(19) United States
(12) Patent Application Publication
(10) Pub. No.: US 2012/0103818 A1
(43) Pub. Date: May 3, 2012

(54) METHOD FOR PREPARING A COATED CURRENT COLLECTOR, A COATED CURRENT COLLECTOR AND AN APPARATUS FOR DE-IONIZING WATER COMPRISING SUCH CURRENT COLLECTOR

(75) Inventors: Hank Robert Reinhoudt, Delft (NL); Albert Van Der Wal, Oegstgeest (NL); Michel Macphail, Leiden (NL)

(73) Assignee: VOLTEA B.V., Sassenheim (NL)

(21) Appl. No.: 13/320,227

(22) PCT Filed: May 12, 2010
(86) PCT No.: PCT/NL2010/000088

§ 371 Date: Dec. 14, 2011

(30) Foreign Application Priority Data
May 13, 2009 (EP) 09160155.9

(51) Int. Cl. B03C 5/02; B05D 5/12

(52) U.S. Cl. 204/660; 427/122

(57) ABSTRACT

Improved flow through capacitors and methods for purifying aqueous solutions. Despite recent developments, the capacity of the electrodes that are used in flow-through capacitor (FTC) stacks still demands improvement. It has been surprisingly found that at least one of these objects is met by FTC electrodes that are made with current collectors coated on both sides which are dried at a temperature range from 15° C. to 120° C.

### FIELD

The present invention relates to a method for preparing a coated current collector.

### DESCRIPTION OF THE RELATED ART

In recent years one has become increasingly aware of the impact of human activities on the environment and the negative consequences this may have. Ways to reduce, reuse and recycle resources are becoming more important. In particular, clean water is becoming a scarce commodity. Therefore, various methods and devices for purifying water have been published.

A method for water purification is by capacitive deionisation, using an apparatus provided with a flow through capacitor (FTC) for removal of ions in water. The FTC functions as an electrically regenerable cell for capacitive deionisation. By charging electrodes, ions are removed from an electrolyte and are held in an electric double layer at the electrodes. The electrodes can be (partially) electrically regenerated to desorb such previously removed ions without adding chemicals.

The apparatus for removal of ions comprises one or more pairs of spaced apart electrodes (a cathode and an anode) and a spacer, separating the electrodes and allowing water to flow between the electrodes. The electrodes may be made by coating a current collector with a coating. The current collector is electrically conductive and transports charge in and out of the coating.

The apparatus is provided with a housing comprising a water inlet to let water in the housing and a water outlet to let water out of the housing. In the housing of the apparatus for removal of ions, the layers of electrodes and spacers are stacked in a “sandwich” fashion by compressive force, normally by mechanical fastening.

A charge barrier may be placed adjacent to an electrode of a flow-through capacitor. The term charge barrier refers to a layer of material which is permeable or semi-permeable and is capable of holding an electric charge. Ions are retained or trapped, on the side of the charge barrier towards which the like-charged ions migrate. A charge barrier may allow an increase in ion removal efficiency, which in turn allows energy efficient ion removal.

Carbon based electrodes are a crucial component of FTC systems and their main function is to store ions during desalination. The capacity of the electrodes that are used in FTC stacks may demand improvements. At present the capacity of the commercially electrodes suitable for a FTC, such as the PACMM series electrodes by Material Methods (trademark), is in the order of 10-25 F/g.

For reference, the electrodes of electrical double layer capacitors (also known as super capacitors) in general have a capacity of up to about 120 F/g, according to B. E. Conway, Electrochemical Super capacitors: Scientific Fundamentals and Technological Applications (Springer, 1999, ISBN: 0306457369). Commercially available electrodes consist of activated carbon particles which are fixed in a Teflon matrix. These commercial electrodes are used in fuel cells as well as in batteries, such as super capacitors. When such super capacitor electrodes are used in a FTC, the measured capacity according to the method in the examples below is in the order of up to 25 F/g and ion storage capacity is relatively low mainly because of poor wetting of the electrodes.

In a FTC, salt is removed from water and therefore the carbon based electrodes should allow the penetration of water. However, the Teflon used in commercial electrodes expels water, which leads to suboptimal performance in a FTC. Carbon based electrodes, which do not use Teflon as a binder and are easily wettable by water are therefore being developed. In those electrodes the carbon particles are bonded together and onto the graphite current collector, for example by using a glue, for example a water based polyacrylate glue or epoxy resin. In order to increase the ion storage capacity of the electrodes, the carbon particles are blended with cationic or anionic polyelectrolytes or mixtures thereof.

The carbon coating of the current collector may have a relatively low density of smaller than about 0.3 g/cm³ of the dry weight. This may be caused by the carbon particles which may have a high degree of micro- and/or mesoporosity and in addition the carbon coatings may contain a high degree of void space. For example, less than half of the coating volume may contain carbon particles and the remaining space may be either filled with air or with water. In order to develop high density electrodes it is required that more of the empty space in the coating is filled with carbon particles, which in turn should also lead to an increase in ion storage capacity.

Therefore, it is an object to provide improved coated current collectors, for use in an apparatus for deionization of water.

### SUMMARY

Accordingly, an embodiment of the present invention provides a method for preparing a coated current collector, the method comprising:
a preparing a coating paste comprising:
   i. dry coating materials comprising:
      50-98.5 dry mass weight % of carbon having a specific surface area of at least 500 m²/g;
      1-40 dry mass weight % of binder;
      0.5-30 dry mass weight % of polyelectrolyte; and
   ii. 20-80% based on the total paste of solvent
b applying the coating paste on one side of the current collector;
c applying the coating paste on another side of the current collector; and,
d drying the coating of the current collector at a temperature range from about 15° C. to about 120° C.

The coating may be applied at both sides simultaneously. Drying the coated current collector may comprise drying at a temperature range from about 30° C. to 120° C. The temperature range may exclude a temperature of about 70° C. The solvent may be an aqueous solvent. The temperature range may comprise a temperature from about 15° C. to smaller than about 70° C. and from larger than 70° C. to smaller than 120° C. The temperature range may comprise a temperature from about 30° C. to about 69° C. and from larger than 71° C. to smaller than 120° C.

An embodiment of the invention may further relate to a method for preparing a coated current collector, the method comprising:
a preparing a coating paste comprising:
   i. dry coating materials comprising:
      50-98.5 dry mass weight % of carbon having a specific surface area of at least 500 m²/g;
      1-40 dry mass weight % of binder;
      0.5-30 dry mass weight % of polyelectrolyte; and
   ii. 20-80% based on the total paste of solvent
b applying the wet coating paste on one side of the current collector;
c applying the wet coating paste on another side of the current collector; and,
d drying the coated current collector so that the thickness of the wet coating paste layers shrinks more than 21%, more than 25%, more than 30% or more than 35%.

The coating may be provided on both sides of the current collector simultaneously. Preparing the coating paste may comprise providing a dispersant other than the polyelectrolyte to the paste.

An embodiment of the invention may relate to a double sided coated current collector, the coating comprising:
a 50-98.5 dry mass weight % of carbon having a specific surface area of at least 500 m²/g;
b 1-40 dry mass weight % of binder; and,
c 0.5-30 dry mass weight % of polyelectrolyte, wherein the abrasiveness of the coating is such that less than 9.25 μm, less than 6 μm or less than 3.13 μm of the coating is removed per stroke in a linear scrubbing rig with a weight of 308 Kg/cm scrubbing over the coating.

An embodiment of the invention may relate to a double sided coated current collector, the coating comprising:
a 50-98.5 dry mass weight % of carbon having a specific surface area of at least 500 m²/g;
b 1-40 dry mass weight % of binder; and,
c 0.5-30 dry mass weight % of polyelectrolyte, wherein the dry mass density of the coating is larger than 0.3, larger than 0.35 or larger than 0.4 g/cm³.

An embodiment of the invention may relate to a double sided coated current, wherein the coating comprises a dispersant other than the polyelectrolyte and a charge barrier is applied to the coating layer, the charge barrier comprising a membrane, selective for anions and/or cations, the charge barrier being applied to the coating layer as a further coating layer or as a laminate layer.

An embodiment of the invention may relate to an apparatus for de-ionizing water comprising the coated current collector described herein.

The coated current collector according to an embodiment of the invention has a higher carbon density, is stronger, and has improved ion storage capacity. In addition, the method should also allow large scale production at similar or lower cost compared to commercially available Teflon® based electrodes.

The main reason for the higher carbon density may be the lower degree of void space in the coated current collector according to an embodiment of the invention. The carbon paste that is used for making the coated electrode has a high water content. The high water content is required, because at lower water levels the paste becomes too viscous, which makes it difficult, if not impossible, to spread onto the current collector. A rapid drying of the electrode at an elevated temperature, immediately after the coating has been applied, may lead to a collapse of the electrode layer, which in turn would give an increase in the density.

The coated current collector of an embodiment of the present invention and the method to provide said coated current collector provides a higher ion storage capacity than the Teflon® based electrodes of the prior art.

These and other aspects, features and advantages will become apparent to those of ordinary skill in the art from a reading of the following detailed description and the appended claims. For the avoidance of doubt, any feature of one aspect of the present invention may be utilised in any other aspect of the invention. It is noted that the examples given in the description below are intended to clarify the invention and are not intended to limit the invention to those examples per se. Similarly, all percentages are weight/weight percentages unless otherwise indicated. Numerical ranges expressed in the format “from x to y” are understood to include x and y. When for a specific feature multiple ranges are described in the format “from x to y”, it is understood that all ranges combining the different endpoints are also contemplated.

### BRIEF DESCRIPTION OF THE DRAWINGS

Embodiments of the invention will now be described, by way of example only, with reference to the accompanying schematic drawings in which corresponding reference symbols indicate corresponding parts and in which:

FIG. 1 is a graph of the amount of NaCl removed by an apparatus for de-ionizing water using a current collector prepared with the method according to an embodiment of the invention;

FIG. 2 is a graph of the conductivity of water coming from the apparatus for de-ionizing water using a current collector prepared with the method according to an embodiment of the invention; and,

FIG. 3 is a graph of the total amount of NaCl removed per gram of activated carbon in the apparatus for de-ionizing water using a current collector prepared with the method according to an embodiment of the invention.

### DETAILED DESCRIPTION OF THE INVENTION

Carbon electrodes, which are used in FTC cells, may be activated by bringing them in a concentrated salt solution. High neutral salt levels in the electrode promote the ion removal capacity as well as ion conductivity and hence speed of removal. However, during use of the FTC cells these ions can slowly leach out of the electrode material, which leads to a reduced electrode overall capacity to remove salt ions from a feed water solution as well as reduced kinetics of salt removal. In addition, high salt levels are required because of the presence of pore volume in the electrode matrix.

Polyelectrolytes are being used to activate the carbon electrodes. One advantage of the polyelectrolyes is that they can adsorb onto the carbon particles, which prevent them from leaching out of the carbon electrode. Another advantage is that lower levels of polyelectrolytes are needed compared to when monovalent salt may be used, because no material is wasted to fill up pore volume.

### Polyelectrolyte

The polyelectrolytes may be both anionic or cationic. The carbon electrodes containing the polyelectrolytes can be used in FTC cells that are built either with or without ion selective membranes. In principle either anionic or cationic polyelectrolytes can be used for both the anode and the cathode. Also mixtures of anionic and cationic polyelectrolytes can be used as well as zwitterionic polymers for both the anode and the cathode. Nevertheless, it is desired to use cationic polymers for the anode and anionic polymers for the cathode to obtain an increase in ion storage capacity.

Suitable cationic polyelectrolytes in the context of an embodiment of the present invention are, for example, nitrogen based polyelectrolytes. Commercially available polyelectrolytes of this type are poly ethylene imines, such as Lupasol® (from BASF), polyquaterniums, such as the Merquat® polyquaterniums (from Nalco), poly amines, and poly vinyl pyridine and its derivatives, as well as cationic polyacrylamides, such as Accepta (from Accepta).

Suitable anionic polyelectrolytes are sulphonated polymers and carboxylated polymers, and mixtures thereof. Commercially available anionic polyelectrolytes are polystyrene sulfonate, such as Flexan® (from National Starch) and polycarboxylates, such as the Sokolan™ series (from BASF)

Both the cationic and anionic polyelectrolytes desirably have a molecular weight of at least 200 D, at least 500 D, or at least 1000 D. The molecular weight is desirably not more than 5,000,000 D, less than 100,000 D, or less than 10,000 D. The polyelectrolytes can be homodisperse or polydisperse covering a broad molecular weight range.

The polyelectrolyte may be present in the coating in a concentration of at least 0.5%, at least 1%, at least 2% or at least 4% by weight of the dry coating. The polyelectrolyte is desirably present in a concentration of not more than 30%, not more than 20%, not more than 15%, or less than 10% by weight of the dry coating. The amount of carbon and polyelectrolyte may be adjusted so as to balance the capacitance of the anode and cathode electrodes. In practice this means that more polyelectrolyte and/or carbon may be used for the anode than for the cathode electrode.

### Binder

The binder may be any conventional adhesive. The binder may be mixable with carbon material. In an embodiment, the binder is a water based adhesive. Binder systems may be selected for their ability to wet the carbon particle or current collector materials, or a surfactant or other agent may be added to the binder mixture to better wet the carbon particles or graphite foil. A dispersant or a dispersing agent is a surface active substance which may be added to the carbon coating paste to improve the dispersion of the carbon particles and by preventing them from settling and clumping throughout manufacture, storage, application and film formation. A dispersant may also be added to the carbon coating paste to stabilize the binder or improve the dispersion of the binder, especially for a binder that is a water based adhesive.

A dispersant may be any type of surfactant or any type of emulsifier and may be selected on the basis of the hydrophilic-lipophilic balance number. The dispersant may be a synthetic detergent, soap, polymeric surfactant or any type of uncharged polymer, especially a water soluble polymer or any mixture thereof. A detergent surfactant can be anionic, cationic or nonionic or a mixture thereof. A surfactant may be sodium dodecyl sulphate, alkyl benzene sulphonate or alkyl ethoxylate and amine oxide surfactant. A dispersant that is used in the inkjet or paint and coating industry, such as Solsperse® and/or Disperbyk® and many others, may also be used.

The dispersant may be similar as the polyelectrolyte. Advantageously, however the dispersant is different than the polyelectrolyte because that makes it possible to optimize both the electrolyte and the dispersant independent of each other. For example the optimal amount of polyelectrolyte may be different than the optimal amount of dispersant by optimizing them independently the dispersant and the polyelectrolyte may be present in the optimal amounts.

Examples of uncharged polymer are polyethylene oxide, polyethylene glycol and polyvinyl pyrrolidone (PVP, e.g. the Luvitec® range or the PVP range from International Speciality Products (ISP)).

A suitable commercial binder material may be a polyacrylic based binder such as the Fastbond™ range from 3M™.

The binder may be present in the coating in a concentration of at least 1%, at least 2%, or at least 5% by weight of the dry coating. The binder is desirably present in the coating in a concentration of less than 50%, less than 40%, less than 30%, less than 20%, or less than 15% by weight of the dry coating.

### Carbon

The carbon in the coating of an embodiment of the present invention comprises activated carbon, and optionally any other carbon material, such as carbon black. The activated carbon may be steam activated or chemically activated carbon, e.g., steam activated carbon, such as DLC A Supra Eur (from Norit). In an embodiment, the carbon has a specific surface area of at least 500 m²/g, at least 1000 m²/g, or at least 1500 m²/g. The anode and cathode may even be made out of different carbon materials. The higher the carbon surface area is, the higher is the ion storage capacity of the current collector. The specific surface area of carbon may for instance be measured by the B.E.T. method, as commonly used in the art.

The carbon may be present in the coating in a concentration of at least 50%, at least 60%, at least 70%, or at least 75% by weight of the dry coating. The composition generally does not contain more than 98.5% by weight of the dry coating of carbon.

### Solvent

The solvent, suitable for mixing the coating paste, may be any solvent suitable for dissolving the polyelectrolyte, such as an aqueous solvent or water. The solvent is generally evaporated from the paste to form a solid coating on the current collector. The evaporation may for instance be achieved by exposure to air (ambient or heated). The solvent may be present in an amount of 20-80% of the total paste, but is generally present in an amount of about 40-50% of the total paste, before drying. After drying, the coating desirably contains less than 25% solvent, less than 15% solvent, or less than 10% solvent.

### Method

In an embodiment of the present invention, there is provided a method of preparing a coated current collector, the method comprising:

preparing a coating paste comprising:
carbon;
binder;
polyelectrolyte; and
solvent

applying the coating paste on a current collector; and

drying the coated current collector.

Drying the coated current collector may be done at a temperature range from 15° C. to 120° C., e.g., 30° C. to 120° C. The temperature range may exclude 70° C. The temperature range may be from 25° C. to smaller than about 70° C., e.g., 69° C. and from larger than 70° C., e.g., 71° C. to smaller than 120° C.

For the manufacturing of the coated current collector, the carbon paste may be applied by paste-, blade-, dip-spray- or spin coating as single layers or multiple layers as well as by gravure roll coating, extrusion coating or by lamination or screen printing. For example, the screen printing process consists of forcing the carbon paste through a stencil covered substrate, e.g. grafoil® or through a wire mesh which has been mounted in a sturdy frame. In this case the carbon paste only goes through the open areas of the stencil and is deposited onto a printing substrate, e.g. grafoil®, positioned below the frame. Manual screen printing can be accomplished with only a few simple items: a sturdy frame, screen fabric, stencils, squeegees, and carbon paste. Automatic press equipment can be used which would greatly speed up the process.

### Dry Electrode

The dry electrode made by the method of an embodiment of the invention, as coated onto the current collector, generally has a thickness of at least 50, at least about 100, or at least about 200 micrometers; and desirably less than 1000 or less than 500 micrometers.

Commercially available electrodes, such as disclosed in U.S. patent application publication no. US2005/0042513, typically have a capacity of 10-25 F/g when applied to a FTC. The electrodes of an embodiment of the present invention generally have a capacity of more than 25 F/g, or at least 30 F/g.

### Current Collector

The current collector may be any common type of current collector. The material of which the current collector is made, is a conducting material. Suitable materials are e.g. carbon, such as graphite, or a carbon mixture with a high graphite content, metal, such as copper, titanium, platinum, (stainless) steel, nickel and aluminium. The current collector is generally in the form of a sheet. Such sheet is herein defined to be suitable to transport at least 33 Amps/m² and up to 2000 Amps/m². When a surface of graphite foil is used, such surface may be corona treated, plasma etched, chemically or mechanically abraded or oxidized to enhance binder adhesion. The thickness of a graphite current collector then typically becomes from 100 to 1000 micrometers, generally 200 to 500 micrometers.

### Charge Barrier Layer

Charge barriers have been disclosed in U.S. Pat. No. 6,709,560 for use in a FTC. An embodiment of the present invention provides a coated current collector, as disclosed herein above, further comprising a charge barrier applied to the electrode coating layer, the charge barrier comprising a membrane, selective for anions or cations, the charge barrier being applied to the electrode coating layer as a further coating layer or as a laminate layer.

In another embodiment, there is provided a system comprising the coated current collector as disclosed herein, comprising carbon, binder and polyelectrolyte, in combination with a separate conventional charge barrier as disclosed in U.S. Pat. No. 6,709,560.

Suitable membrane materials may be homogeneous or heterogeneous. Suitable membrane materials comprise anion exchange and/or cation exchange membrane materials, desirably ion exchange materials comprising strongly dissociating anionic groups and/or strongly dissociating cationic groups. Examples of such membrane materials are Neosepta™ range materials (from Tokuyama), the range of PC-SA™ and PC-SK™ materials (from PCA GmbH), ion exchange membrane materials from Fumatec, ion exchange membrane materials such as the Ralex™ material (from Mega) or the Excellion™ range of heterogeneous membrane material (from Snowpure).

### Stack

A FTC normally comprises at least one repeating unit of:
an anionic current collector/electrode
optionally an anion exchange membrane as charge barrier
a conventional FTC spacer
optionally a cation exchange membrane as charge barrier
a cathode current collector/electrode.

In practice the number of repeating units in a stack may be limited, for example, by the number of current collectors that can be practically bundled and connected to the connector or by the required stack compression force. In practice this means that a conventional FTC stack typically comprises 1 to 20 repeating units. The coated current collector may have a lower contact resistance between electrode and current collector, resulting in a lower required compression force per repeating unit. Therefore the required compression force for the same number of repeating units may be lower, or the number of repeating units in the FTC can be increased at constant compression force. It is desired that the number of repeating units in a FTC be at least 1, at least 5, at least 10, or at least 20. For practical reasons, the number of repeating units is generally not more than 200, not more than 150, not more than 100, or not more than 50.

The stack may be compressed at a pressure of less than 3 bar, in an embodiment not more than 1 bar, not more than 0.3 bar, or less than 0.1 bar.

The coated current collector of an embodiment of the present invention enables the configuration of a FTC stack in spirally wound form, amongst others, due to the lower electrical contact resistance of the carbon coated current collector. In such a spirally wound configuration, the FTC stack typically comprises at least 1 repeating unit. Typically the FTC stack in spirally wound form comprises less than 20 repeating units.

### Applications of the Coated Current Collector FTC

The coated current collector is especially useful in a FTC device that requires low system cost, for example in a domestic appliance such as a coffee maker, espresso machine, washing machine, dish washer, refrigerator with ice or water dispenser, steam iron, etc, where the removal of hardness ions such as calcium and magnesium, as well as other ions is beneficial. The coated current collector can also be used for residential water treatment such as point of use devices as well as point of entry devices for whole households. The coated current collector can also be used for commercial and industrial applications, e.g. water treatment in agriculture (e.g. treatment of ground water and surface water), boiler water, cooling towers, process water, pulp and paper, laboratory water, waste water treatment, mining as well as for the production of ultra pure water. Finally the coated current collector may be used for the removal of problem ions such as nitrate in e.g. swimming pools and arsenic and/or fluoride in e.g. ground water.

An embodiment of the invention will now be illustrated by means of the following non-limiting examples.

### EXAMPLE 1

Preparation of an anode coated current collector (total dry weight: 4 g).
Dilute polyethyleneimine (Lupasol® from BASF) into water in order to obtain a 20% weight solution.
Introduce 2.8 g of the 20% weight polyelectrolyte solution in a beaker.
Add 4 g of water and mix to get a homogeneous solution.
Add approximately 1.6 g of carbon particles (A Supra Eur from Norit) and mix until the particles are fully dispersed.
Add the rest of the carbon particles (the total amount of carbon has to be 3.20 g) and mix until the particles are fully dispersed.
Introduce 0.46 g of the binder and mix to get a homogeneous mixture.
Check the viscosity of the mixture: if it is too viscous, add some water or if it is too liquid, wait a few minutes, some water will evaporate.
Spread the paste on the graphite foil (speed: 5 mm/s).

Anode Coating Composition
Polyelectrolyte: polyethylenimine PEI from BASF (Lupasol®)→14%
Activated carbon: A Supra Eur from Norit→80%
Binder: Scotch-Weld/Pressure Sensitive Adhesive from 3M™→6%

Preparation of a cathode coated current collector is done in a similar way except that the polyelectrolyte is replaced by an electrolyte specifically suited for a cathode, e.g. Flexan II, poly(4-styrenesulfonate) Mw: 130000 (from National Starch)

The desalination results have been tested in a small FTC cell (Mini Cell), containing a single unit cell (total electrode area: 36 cm²) as well as in a small FTC stack which can contain up to 13 repeating unit layers (total electrode area ca 1000 cm²).

TABLE 1
Measured thicknesses of dried electrodes for different applied coatings
thickness, showing the effect of drying temperature.

| | Thickness coating | | | Thickness coating | | |
|---|---|---|---|---|---|---|
| | dried at room | | | dried at 75° C. | | |
| | temperature (ca 24° C.) | | | temperature | | |
| | | % | | Meas- | % | |
| Applied | Measured | (measured/ | % | ured | (measured/ | % |
| (μm) | (μm) | applied) | loss | (μm) | applied) | loss |
| 100 | 97.5 | 97.5 | 2.5 | 70.0 | 70.0 | 30.0 |
| 250 | 205 | 82.0 | 18.0 | 157.5 | 63.0 | 37.0 |
| 350 | 277.5 | 79.3 | 20.7 | 242.5 | 69.3 | 30.7 |
| 450 | 362.5 | 80.6 | 19.4 | 350.0 | 77.8 | 22.2 |

Table 1 shows that when the electrodes are dried in an oven at 75° C., then a significant reduction in electrode thickness is observed. For example, for a coating at an applied thickness of 250 μm (a characteristic thickness for carbon electrodes in FTC), a shrinkage of 37% is observed when the electrodes are dried at 75° C. compared to only 18% when dried at room temperature. This means that significantly denser electrodes can be obtained when the carbon coatings are dried at elevated temperatures.

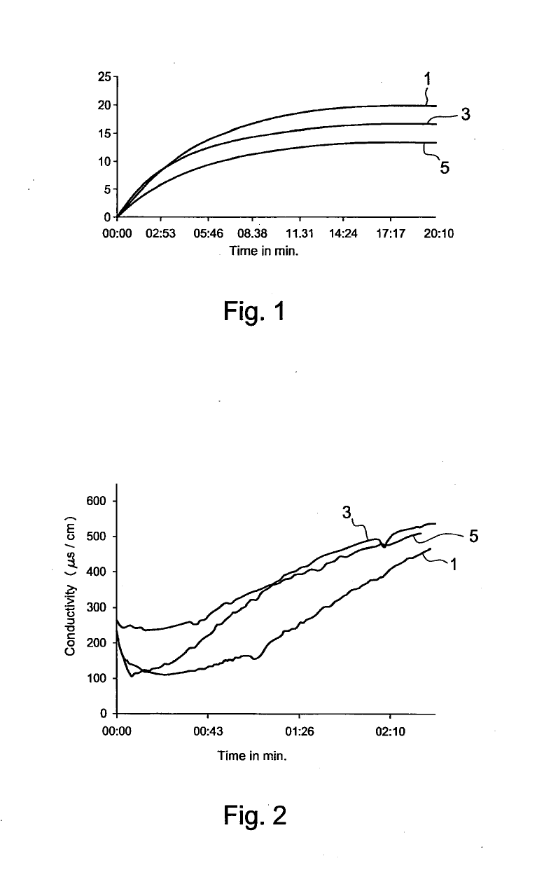

FIG. 1 is a graph of the amount of NaCl removed by an FTC apparatus for de-ionizing water using a current collector prepared with the method according to an embodiment of the invention. FIG. 1 shows the speed of ion adsorption as well as the maximum ion adsorption capacity for the carbon coated electrodes, which are dried at room temperature 3 as well as at 75° C. 1. The amount of NaCl removed is measured in mg NaCl per gram carbon and the amount is measured over a time period from 0 to 20:10 minutes. For comparison is included the results for a good quality commercial electrode 5. Nevertheless, FIG. 1 shows that both coated electrodes outperform the commercial electrodes and also that the coatings that were dried at the higher temperature have about 20% higher ion storage capacity on a weight by weight basis. The ion adsorption onto different carbon electrodes was measured in a Mini Cell.

In order to further test the coated electrodes in a FTC system, a small FTC stack, which contained 26 layers of carbon at a total weight of 9.724 g, was used. At a same weight basis, 18 layers of commercial Teflon based electrodes were used.

FIG. 2 is a graph of the conductivity of water coming from an apparatus for de-ionizing water using a current collector prepared with the method according to an embodiment of the invention. FIG. 2 shows salt removal in a small FTC stack during 150 sec of desalination for current collectors coated at 75° C. 1, at room temperature 3 as well as for commercial electrodes 5. The feed water contained 500 ppm NaCl and the flow rate was 100 ml/min. FIG. 2 shows that the desalination efficiency is higher for the coated electrodes compared to the commercial electrodes. The desalination continues longer for the electrode 1 comprising a coated current collector according to an embodiment of the invention and also the total amount of removed salt is higher for this coated current collector. Again the coatings that have been dried at 75° C. 1 outperform those that have been dried at room temperature 2. More specifically, the electrodes that have been dried at 75° C. remove about 47% more salt than the commercial electrodes in a typical FTC experiment.

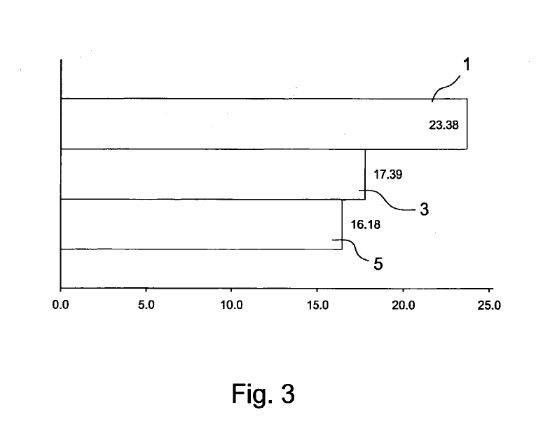

FIG. 3 is a graph of the total amount of NaCl removed per gram of activated carbon in an apparatus for de-ionizing water using a current collector prepared with the method according to an embodiment of the invention 1, a current collector dried at room temperature 24° C. 3 and commercial electrodes 5. Again, the coatings that have been dried at 75° C. 1 outperform those that have been dried at room temperature 3 and the commercial electrodes 5.

### Example 2

An abrasion test has been done with a linear scrubbing rig, which comprises a plateau onto which the coated electrode with an applied coating thickness layer of 250 μm is fixed and a moving arm having at the end a half cylindrical surface placed perpendicular onto the arm, where the cylindrical surface is made from PVC with a curvature of 1.5 cm and a width of 6 cm. Different weights can be placed on top of the cylinder and for an experiment a weight of 1850 kg was used such that there was (1850/6) 308 Kg/cm. The arm moves with a speed of 30 strokes/min. The total area that is used for the abrasion test is 120 cm² of coated electrodes and the assessment was made on 36 cm² electrode area. As a measure of abrasion resistance the number of strokes that are needed before the grafoil® current collector becomes visible to the eye was measured, after which the experiment was stopped. The more strokes that are needed the more abrasion resistant the electrodes are. Alternatively an ASTM D4060 Taber abrasion tester may be used.

Table 2 shows the number of strokes that are needed before grafoil becomes visible to the bare eye for electrodes that have been dried for 2 hours at room temperature and for electrodes that have been dried for 2 hours at 80° C.

| Temperature | Number Strokes |
|---|---|
| 24° C. | 27 |
| 80° C. | 80 |

The coated current collectors with the higher abrasion resistivity also have an improved salt removal capacity over the coated current collectors with a lower abrasion resistivity. The abrasion resistivity is such that less than 9.25 μm (250 μm/27 strokes) per stroke is removed from the coating layer if the electrodes have been dried at more than 24° C. In an embodiment, the abrasion resistivity is such that 3.13 μm (250 μm/80 strokes) is removed from the coating layer if the electrode has been dried at 80° C.

Carbon coated electrodes have excellent salt removal capacity compared with good quality commercial electrodes. The differences are becoming larger when the wet coatings are dried at increased temperatures. This also has advantages for the manufacturing of the coated electrodes because of reduced drying times and shorter production lines. In addition, the heat treated electrodes are more compact and more resistant to abrasion, which is another key advantage in the manufacture and handling of the electrodes.

While specific embodiments of the invention have been described above, it will be appreciated that the invention may be practised otherwise than as described. The description is intended to be illustrative, not limiting. Thus, it will be apparent to one skilled in the art that modifications may be made to the invention as described without departing from the scope of the claims set out below.

1. A method of preparing a coated current collector, the method comprising:
a preparing a coating paste comprising:
i. dry coating materials comprising:
50-98.5 dry mass weight % of carbon having a specific surface area of at least 500 m²/g;
1-40 dry mass weight % of binder;
0.5-30 dry mass weight % of polyelectrolyte, which adsorbs onto the carbon and which cannot substantially leach out of the carbon;
a dispersant different than the polyelectrolyte to improve the dispersion of the carbon particles; and,
ii. 20-80% based on the total paste of solvent
b applying the coating paste on one side of the current collector;
c applying the coating paste on another side of the current collector; and,
d drying the coating of the current collector at a temperature range from about 15° C. to about 120° C.

2. The method according to claim 1, wherein the temperature range comprises from about 30° C. to about 120° C.

3. The method according to claim 1, wherein the temperature range excludes a temperature of about 70° C.

4. The method according to claim 1, wherein the solvent is an aqueous solvent.

5. The method according to claim 1, wherein the temperature range comprises a temperature from about 15° C. to smaller than about 70° C. and from larger than about 70° C. to smaller than about 120° C.

6. The method according to claim 1, wherein the temperature range comprises a temperature from about 30° C. to about 69° C. and from larger than about 71° C. to smaller than about 120° C.

7. The method according to claim 1, wherein the carbon paste is applied by paste-, blade-, dip-spray- or spin coating or by gravure roll coating, extrusion coating or by lamination or screen printing.

8. A method of preparing a coated current collector, the method comprising:
a preparing a coating paste comprising:
i. dry coating materials comprising:
50-98.5 dry mass weight % of carbon having a specific surface area of at least 500 m²/g;
1-40 dry mass weight % of binder;
0.5-30 dry mass weight % of polyelectrolyte which adsorbs onto the carbon and which cannot substantially leach out of the carbon;
a dispersant different than the polyelectrolyte to improve the dispersion of the carbon particles; and
ii. 20-80% based on the total paste of solvent
b applying the wet coating paste on one side of the current collector;
c applying the wet coating paste on another side of the current collector; and,
d drying the coated current collector so that the thickness of the wet coating paste layers shrink more than 21%.

9. The method according to claim 8, wherein the coating is provided on both sides of the current collector simultaneously.

10. The method according to claim 8, wherein preparing the coating paste comprises providing a dispersant other than the polyelectrolyte to the paste.

11. A double sided coated current collector, the coating comprising:
a 50-98.5 dry mass weight % of carbon having a specific surface area of at least 500 m²/g;
b 1-40 dry mass weight % of binder;
c 0.5-30 dry mass weight % of polyelectrolyte, which adsorbs onto the carbon and which cannot substantially leach out of the carbon, and,
d a dispersant different than the polyelectrolyte to improve the dispersion of the carbon particles; wherein the abrasiveness of the coating is such that less than 9.25 μm of the coating is removed per stroke in a linear scrubbing rig with a weight of 308 Kg/cm scrubbing over the coating.

12. A double sided coated current collector, the coating comprising:
a 50-98.5 dry mass weight % of carbon having a specific surface area of at least 500 m²/g;
b 1-40 dry mass weight % of binder; and,
c 0.5-30 dry mass weight % of polyelectrolyte, which adsorbs onto the carbon and which cannot substantially leach out of the carbon, and,
d a dispersant different than the polyelectrolyte to improve the dispersion of the carbon particles; wherein the dry mass density of the coating is larger than 0.3 g/cm³.

13. The double sided coated current collector according to claim 11, wherein a charge barrier is applied to the coating layer, the charge barrier comprising a membrane, selective for anions and/or cations, the charge barrier being applied to the coating layer as a further coating layer or as a laminate layer.

14. An apparatus to de-ionize water, the apparatus comprising the coated current collector according to claim 11.

15. An apparatus to de-ionize water, the apparatus comprising a stack comprising:
a an anode comprising a coated current collector according to claim 12;
b a spacer; and,
c a cathode comprising a coated current collector according to claim 12.

16. The method according to claim 1, wherein the coating is provided on both sides of the current collector simultaneously.

17. The method according to claim 1, wherein preparing the coating paste comprises providing a dispersant other than the polyelectrolyte to the paste.

18. The method according to claim 8, wherein the thickness of the wet coating paste layers shrink more than 35%.

19. The double sided coated current collector according to claim 11, wherein the abrasiveness of the coating is such that less than 6 μm of the coating is removed per stroke in a linear scrubbing rig with a weight of 308 Kg/cm scrubbing over the coating.

20. The double sided coated current collector according to claim 12, wherein a charge barrier is applied to the coating layer, the charge barrier comprising a membrane, selective for anions and/or cations, the charge barrier being applied to the coating layer as a further coating layer or as a laminate layer.

21. The double sided coated current collector according to claim 12, wherein the dry mass density of the coating is larger than 0.4 g/cm³.
